(19) United States
(12) Patent Application Publication
(10) Pub. No.: US 2019/0215407 A1
(43) Pub. Date: Jul. 11, 2019

(54) SCAN BAR CALIBRATION

(71) Applicant: Hewlett-Packard Development Company, L.P., Spring, TX (US)

(72) Inventors: Hsue-Yang Liu, Vancouver, WA (US); Milan Crowley Justel, Vancouver, WA (US); Curtis J Behrend, San Diego, CA (US)

(21) Appl. No.: 16/331,570

(22) PCT Filed: Sep. 9, 2016
(86) PCT No.: PCT/US2016/051013

§ 371 Date: Mar. 8, 2019

(51) Int. Cl. H04N 1/00; H04N 1/04

(52) U.S. Cl. CPC H04N 1/00087; H04N 1/00063; H04N 1/00018; H04N 1/04

(57) ABSTRACT

Example implementations relate to scan bar calibration. For example, a system for scan bar calibration may include instructions executable by a processing resource to implement a plurality of scanning settings at a scan bar index location of a scanning device. The system may further include instructions to execute a scan bar calibration of a calibration target at the scan bar index location, and generate a scan bar calibration table for the scan bar index location based on the executed scan bar calibration.

### BACKGROUND

Scan bars may be used in scanning devices such as digital cameras, camcorders, and scanners. Scan bars may consist of a large number of photo detectors also called pixels. Pixels may be comprised of silicon and capture light by converting photons into electrons using the photoelectric effect. The accumulated charge may be transferred out of the scan bar, amplified, converted to a digital signal, and further processed before the data is stored in an image format.

### BRIEF DESCRIPTION OF THE DRAWINGS

FIG. 1 illustrates an example environment for scan bar calibration according to the present disclosure.

FIG. 2 illustrates a block diagram of an example system for scan bar calibration according to the present disclosure.

FIG. 3 further illustrates a block diagram of an example system or scan bar calibration according to the present disclosure.

FIG. 4 illustrates an example method for scan bar calibration according to the present disclosure.

FIG. 5 further illustrates an example method for scan bar calibration according to the present disclosure.

### DETAILED DESCRIPTION

A scanning device may include a scan bar to optically scan images, printed text, handwriting, and/or an object, and convert it to a digital image. Due to the mechanical tolerance of the scan bar subsystem, the paper shape may impact scan quality. As used herein, the “paper shape” refers to variety in the surface of the print media that affects the spacing between the scan bar and the media. Although paper is chosen as an example of print media for the sake of description, examples are not so limited and the disclosure herein applies to print media other than paper. Also, as used herein, the scan bar subsystem refers to the portion of the scanning device that contains the scan bar. That is, in some scanning devices, there may be a high degree of sensitivity in image quality in response to scan bar to media spacing variation. Moreover, due to the size of the scan bar relative to the media being scanned, the scan bar may move to multiple locations to scan the entire surface of the media. For example, in order to scan an A4 format document, the scan bar may relocate 3 or 4 times to scan the entire document surface and gain more measurement averaging. As used herein, a location of the scan bar relative to the media being scanned is referred to as a “scan bar index location”. Due to the mechanical tolerance of the scan bar, the paper shape may impact the compensation between scan bar index locations. The media stiffness and scanning environment may also impact the paper shape.

Scan bar calibration, according to the present disclosure, may provide more accurate calibration of scan bars, and therefore the scanning devices utilizing them. Moreover, scan bar calibration according to the present disclosure, may provide for more consistent quality of image capture, as the calibrated scan bar may take into consideration the paper shape while scanning.

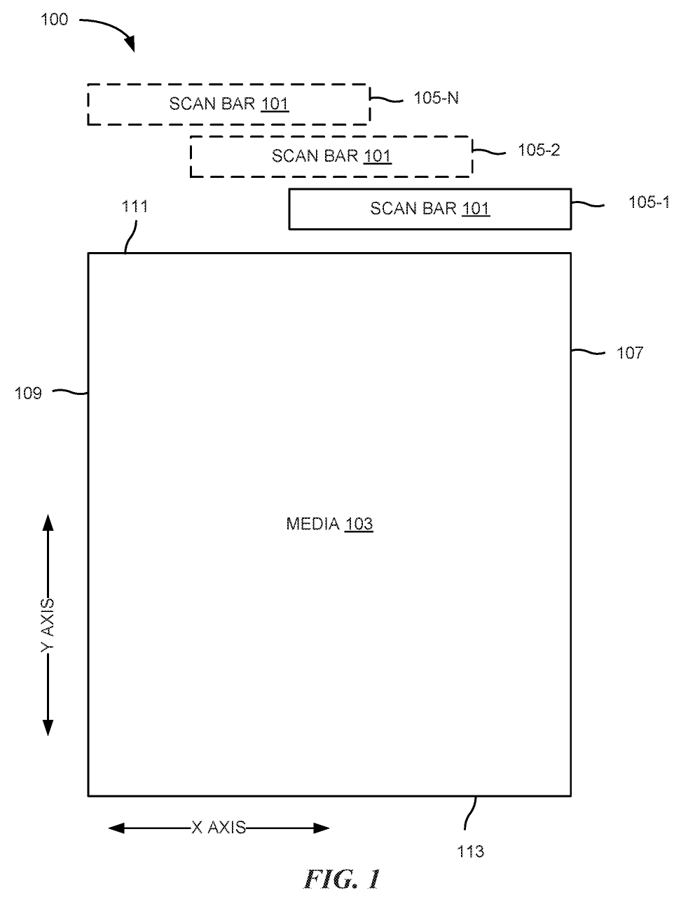

FIG. 1 illustrates an example environment 100 for scan bar calibration, according to the present disclosure. As illustrated in FIG. 1, a scan bar 101 may be located in many different scan bar index locations, 105-1, 105-2, . . . 105-N (referred to collectively as scan bar index locations 105). Again, as used herein, a scan bar index location refers to a location of the scan bar 101 relative to the media 103 being scanned.

For example, scan bar 101 may be located in a first scan bar index location 105-1. Scan bar index location 105-1, as illustrated, may correspond to the positioning of the scan bar 101 along edge 107 of media 103. That is, in scan bar index location 105-1, scan bar 101 may scan from edge 111 to edge 113 along edge 107 of media 103. In such a manner, positioning the scan bar 101 in scan bar index location 105-1 may allow for scanning of approximately one third (⅓) of the surface of media 103.

Similarly, scan bar 101 may be located in a second scan bar index location 105-2. Although scan bar index location 105-2 is illustrated in FIG. 1 as having a different position in the Y-axis than scan bar index location 105-2, it is noted that such representation is for illustrative purposes. In each of scan bar index locations 105-1, 105-2, and 105-N, the scan bar 101 may begin scanning media 103 in a same position in the Y-axis, but a different respective position in the X-axis. That is, referring to FIG. 1, scan bar index location 105-2 may be positioned to the left of scan bar index location 105-1, such that in scan bar index location 105-2, the scan bar 101 may scan from edge 111 to edge 113 along the center of the media 103. IN such a manner, scan bar index location 105-2 may allow for scanning of the center one third of media 103. Moreover, scan bar index location 105-N may be positioned to the left of scan bar index location 105-2, such that he scan bar 101 may scan from edge 111 to edge 113 along edge 109 of media 103. As such, by moving scan bar 101 between each of the scan bar index locations 105, scan bar 101 may scan an entire surface of media 103.

As described herein, the scan bar 101 may be calibrated at each scan bar index location, and a scan bar calibration table may be generated to ensure consistent scanning of the media 103, given variation in the paper shape.

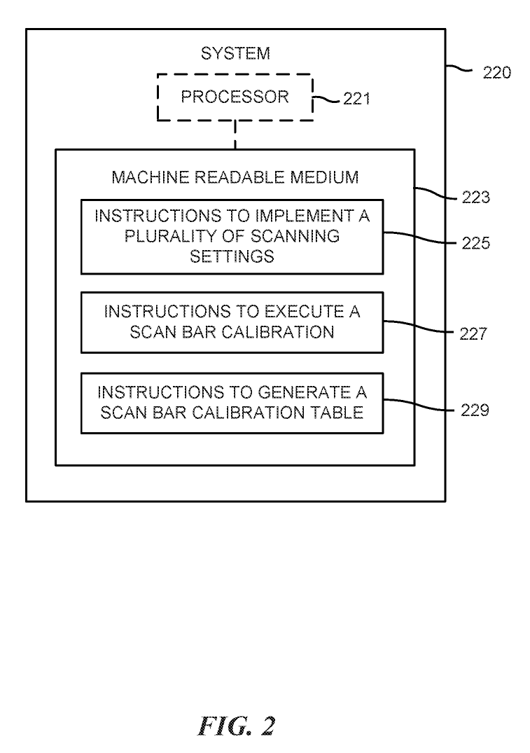

FIG. 2 is a block diagram of an example system 220 for scan bar calibration according to the present disclosure. System 220 may include at least one computing device that is capable of communicating with at least one remote system. In the example of FIG. 2, system 220 includes a processor 221 and a machine-readable medium 223. Although the following descriptions refer to a single processor and a single machine-readable medium, the descriptions may also apply to a system with multiple processors and machine-readable mediums. In such examples, the instructions may be distributed (e.g., stored) across multiple machine-readable mediums and the instructions may be distributed (e.g., executed by) across multiple processors.

Processor 221 may be one or more central processing units (CPUs), microprocessors, and/or other hardware devices suitable for retrieval and execution of instructions stored in machine-readable medium 223. In the particular example shown in FIG. 2, processor 221 may receive, determine, and send instructions 225, 227, and 229 for scan bar calibration. As an alternative or in addition to retrieving and executing instructions, processor 221 may include one or more electronic circuits comprising a number of electronic components for performing the functionality of one or more of the instructions in machine-readable medium 223. With respect to the executable instruction representations (e.g., boxes) described and shown herein, it should be understood that part or all of the executable instructions and/or electronic circuits included within one box may, in alternate embodiments, be included in a different box shown in the figures or in a different box not shown,

Machine-readable medium 223 may be any electronic, magnetic, optical, or other physical storage device that stores executable instructions. Thus, machine-readable medium 223 may be, for example, Random Access Memory (RAM), an Electrically-Erasable Programmable Read-Only Memory (EEPROM), a storage drive, an optical disc, and the like. Machine-readable medium 223 may be disposed within system 220, as shown in FIG. 2. In this situation, the executable instructions may be “installed” on the system 220. Additionally and/or alternatively, machine-readable medium 223 may be a portable, external or remote storage medium, for example, that allows system 220 to download the instructions from the portable/external/remote storage medium. In this situation, the executable instructions may be part of an “installation package”. As described herein, machine-readable medium 223 may be encoded with executable instructions for scan bar calibration.

Referring to FIG. 2, instructions 225, when executed by a processor (e.g., 221), may cause system 220 to implement a plurality of scanning settings at a scan bar index location of a scanning device. That is, referring to FIG. 1, a plurality of scanning settings may be applied at each of locations 105-1, 105-2, and 105-N. In some examples, the instructions 225 to implement the plurality of scanning settings may include instructions to implement a particular resolution and color channel for the calibration. That is, a particular application may utilize a particular resolution and/or color channel for scanning and/or printing, and therefore may be associated with particular scanning settings. In another example, a particular type of ink cartridge and/or scan bar may be associated with a particular resolution and/or a particular color channel.

Instructions 227, when executed by a processor (e.g., 221), may cause system 220 to execute a scan bar calibration of a calibration target at the scan bar index location. Again, referring to FIG. 1, a scan bar calibration may be performed at a scan bar index location. For instance, a scan bar calibration may be performed at scan bar index location 105-1. During the scan bar calibration at scan bar index location 105-1, the scan bar calibration may be performed at the particular resolution and color channel. The scan bar (e.g., scan bar 101) may pass along the length of the media (e.g., along the Y-axis of media 103 illustrated in FIG. 1) and generate a photo response non-uniformity (PRNU) profile defining the paper shape for the scan bar index location 105-1. Such process may be repeated at each of scan bar index locations 105-2 and 105-N. As used herein, a “calibration page” refers to any print medium used for calibration. Also, as used herein, a “calibration target” refers to an area on the calibration page that is used for calibration of the scan bar. A calibration target may include white space, such as print media without ink or other printing material, and/or a printed area.

Moreover, instructions 229, when executed by a processor (e.g., 221), may cause system 220 to generate a scan bar calibration table for the scan bar index location based on the executed scan bar calibration. That is, a scan bar calibration table may be generated for scan bar index location 105-1. As used herein, a “scan bar calibration table” refers to a set of instructions to correct for the paper shape. For example, the scan bar calibration table may include instructions to correct for the paper shape within the scan bar index location 105-1, 105-2, and 105-N. Examples are not so limited, however and the scan bar calibration table may also include instructions to correct for scan bar to scan bar variation. That is, between each scan bar index location, the output of the scan may appear different, and therefore the digital image generated at each scan bar index location may be corrected to blend with the digital images generated at the other scan bar index locations.

In some examples, the system 220 may include instructions executable by the processor 221 to measure a paper shape on a calibration page, where the calibration page includes the calibration target. That is, the scan bar may measure the distance between the scan bar and the medium to measure the paper shape. The system 220 may then modify the scan bar calibration table based on the measured paper shape. Furthermore, the system 220 may rescan the calibration target with the modified scan bar calibration tables. In such a manner, system 220 may calibrate itself to account for variation in the shape of the media. Put another way, a scan bar within a scanning device may be calibrated, and the scanning device itself may be calibrated based on the calibration of the scan bar.

In some examples, the system 220 may include instructions executable by the processor 221 to estimate a paper shape profile for each of a plurality of scan bar index locations, and use the estimated paper shape profile to perform background compensation for a scanned image. As used herein, a “paper shape profile” refers to a set of instructions defining the shape of a particular type and/or piece of media. Based on the paper shape profile, the scan bar may be configured in a particular manner to account for the paper shape profile. For instance, a particular type of media may have a specific shape, and as such, the scan bar may use the same scan bar calibration table in subsequent scans using the same type of media.

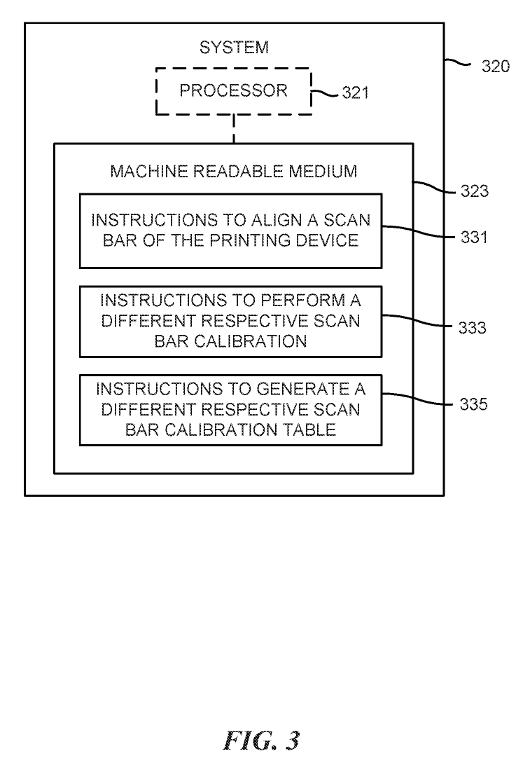

FIG. 3 further illustrates a block diagram of an example system 320 for scan bar calibration, according to the present disclosure. System 320 may be the same as or different than, the system 220 illustrated in FIG. 2. That is, system 320 includes a processor 321 and a machine-readable medium 323 analogous to processor 221 and machine-readable medium 223 illustrated in FIG. 2.

As illustrated in FIG. 3, system 320 may include instructions 331 to align a scan bar of the scanning device in each of a plurality of scan bar index locations. That is, the instructions 331 may include instructions to align the scan bar in a first scan bar index location among the plurality of scan bar index locations. For example, referring to FIG. 1, instructions 331 may include instructions to align the scan bar 101 in scan bar index location 105-1. System 320 may further include instructions to pass a medium including a calibration target longitudinally across the scan bar. Again, referring to FIG. 1, environment 100 may include a mechanism or mechanisms to move media 103 in a direction along the Y-axis. As such, system 320 may include instructions to move media 103 along the Y-axis over scan bar 101 a number of times during calibration. To that end, system 320 may include instructions to perform a scan bar calibration at the first scan bar index location.

To further elaborate, the instructions 331 to align the scan bar may include instructions to align the scan bar in a second scan bar index location among the plurality of scan bar index locations, where the second scan bar index location is different than a first scan bar index location. That is, the scan bar 101 in FIG. 1 may be aligned in scan bar index location 105-2. Therefore, the system 320 may include instructions 333 to perform a different respective scan bar calibration at each of the plurality of scan bar index locations. Put another way, the scan bar may perform a first scan bar calibration at scan bar index location 105-1, a second scan bar calibration at scan bar index location 105-2, and a third scan bar calibration at scan bar index location 105-N.

Moreover, system 320 may include instructions 335 to generate a different respective scan bar calibration table for each of a plurality of scan bar index locations using information from the associated scan bar calibration. That is, a scan bar calibration may be performed at a first scan bar index location (such as 105-1), and a first scan bar calibration table may be generated for the first location. A scan bar calibration may be performed at a second scan bar index location (such as 105-2), and a second scan bar calibration table may be generated, and so forth. In such examples, the first scan bar calibration table and the second scan bar calibration table, etc. may be used to calibrate the entire scanning device.

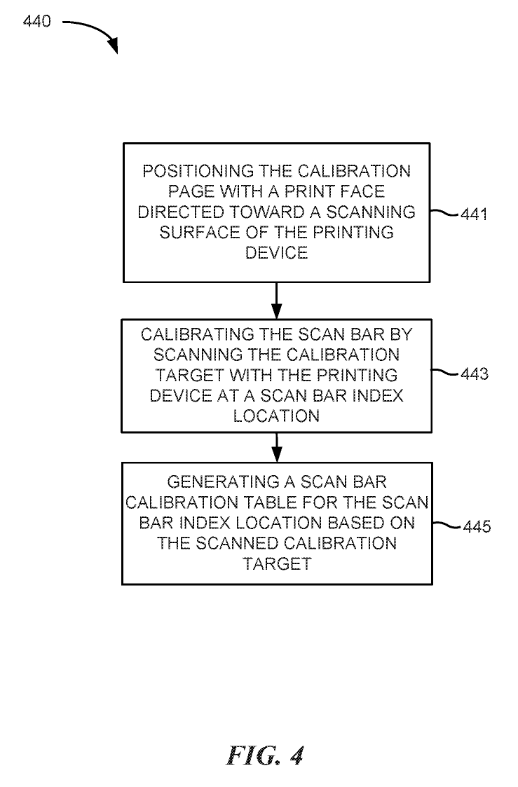

FIG. 4 illustrates an example method 440 for scan bar calibration according to the present disclosure. At 441, the method 440 includes positioning a calibration page with a print face directed toward a scanning surface of a scanning device, where the calibration page includes a calibration target. In some examples, positioning the calibration page with the print face directed toward the scanning surface of the scanning device may include performing a duplex print of the calibration page, though examples are not so limited.

At 443, the method 440 may include calibrating the scan bar by scanning the calibration target with the scanning device at a scan bar index location, as discuss with regard to FIGS. 1-3. In some examples, scanning the calibration target may include performing a scan bar calibration for a selected channel and resolution with white space above the calibration target. That is, the scan bar calibration may be performed in a location of the media where less than a threshold amount of white space remains between the target and an edge of the media. Examples are not so limited, however, and scan bar calibration may be performed in any region of the media.

At 445, the method 440 may include generating a scan bar calibration table for the scan bar index location based on the scanned calibration target. That is, the scan bar may be calibrated at a particular scan bar index location, and data may be gathered regarding the shape of the media within that scan bar index location. A scan bar calibration table may then be generated with the data gathered during the scan bar calibration.

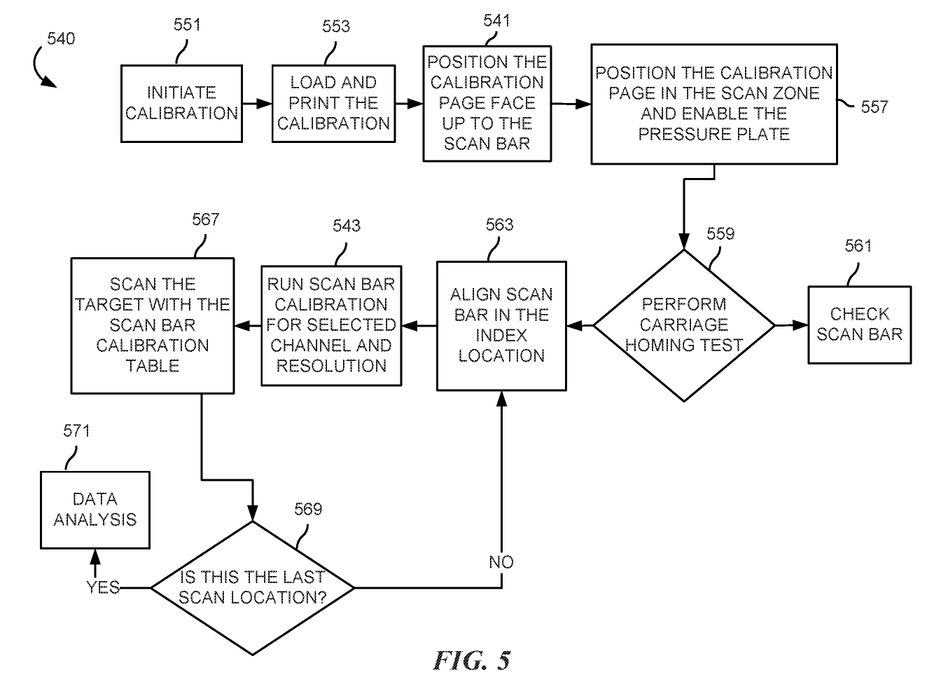

FIG. 5 further illustrates an example method 540 for scan bar calibration according to the present disclosure. Method 540 may be analogous to method 440 illustrated in FIG. 4.

As illustrated at 551, the method 540 may include initiating calibration of the scan bar. At 553, the method 540 may include loading and printing a calibration page. As described herein, the calibration page may include a calibration target or a plurality of calibration targets.

At 541, the method 540 may include positioning the calibration page “face up” to the scan bar. As used herein, a “face up” orientation of the calibration page refers to an orientation of the calibration page with printed material facing the scan bar.

At 557, the method 540 may include positioning the calibration page in the scan zone, and enabling a pressure plate. That is, positioning the calibration page with the print face directed toward the scanning surface may include engaging a pressure plate in the scanning device to maintain the calibration page against the scanning surface, such as a glass surface of the scanner. As used herein, a “scanning surface” refers to a surface such as glass that protects the scan bar from the media being scanned. Also, as used herein, a “pressure plate” refers to a mechanical component within the scanning device that, when engaged, applies pressure to hold the media against the scanning surface,

At 559, the method 540 may include performing a carriage homing test on the scanning device. As used herein, a “homing test” refers to a test to determine if the scan bar of the scanning device is properly aligned. That is, the homing test may determine if the scan bar is improperly aligned within the scanning device due to mechanical failure or other defect. If the carriage homing test is successful, a 563, the method 540 may include aligning the scan bar in a particular scan bar index location. As described herein, the scan bar may be configured by beginning in a first scan bar index location, and proceeding to the other scan bar index locations. Put another way, the method 540 may include aligning the scan bar at a particular scan bar index location in response to a determination that the carriage homing test was successful.

Similarly, at 561, the method 540 may include checking the scan bar for errors that may contribute to failure of the carriage homing test. That is, if at 559 the carriage homing test fails, the method 540 may include checking the scan bar for errors or defects at 561.

At 543, the method 540 includes running a scan bar calibration for a selected channel and resolution, at a particular scan bar index location. For example, as describe herein, the scan bar may be calibrated at each of a plurality of scan bar index locations, using a defined resolution and/or color channel.

Moreover, at 567, the method 540 may include scanning the target with the scan bar calibration table. As described herein, the scan bar may be calibrated, and data gathered therein. A scan bar calibration table or a plurality of scan bar calibration tables may be generated, which allows for the scanning device itself to be calibrated. As such, at 567, the calibration target may be scanned with the generated scan bar calibration table(s).

In some examples, the method 540 may include at 569, determining if the scan bar index location is the last scan bar index location. For example, referring to FIG. 1, a determination may be made whether the scan bar 101 has been calibrated at each of scan bar index locations 105-1, 105-2, and 105-N. If the scan bar index location calibrated is not the last scan bar index location, then the method 540 returns to 563 and aligns the scan bar in another scan bar index location etc. If, however, a determination is made that the scan bar index location calibrated is the last scan bar index location, then the method 540 may proceed to 571 and analyze data for scanning. Put another way, the method 540 may include determining if the scan bar index location calibrated is a last scan bar index location, and moving the scan bar to a second scan bar index location in response to a determination that the first scan bar index location is not the last scan bar index location.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, the designators “N”, “M”, “P”, and “R”, particularly with respect to reference numerals in the drawings, indicates that a number of the particular feature so designated can be included with examples of the present disclosure. As used herein, “a number of” an element and/or feature can refer to one or more of such elements and/or features.

What is claimed:

1. A non-transitory machine readable medium storing instructions executable by a processing resource to:
implement a plurality of scanning settings at a scan bar index location of a scanning device;
execute a scan bar calibration of a calibration target at the scan bar index location; and
generate a scan bar calibration table for the scan bar index location based on the executed scan bar calibration.

2. The medium of claim 1, wherein the instructions to implement the plurality of scanning settings include instructions to implement a particular resolution and color channel for the calibration.

3. The medium of claim 1, including instructions to:
measure a paper shape on a calibration page, wherein the calibration page includes the calibration target;
modify the scan bar calibration table based on the measured paper shape; and
rescan the calibration target with the modified scan bar calibration tables.

4. The medium of claim 1, including instructions to:
estimate a paper shape profile for each of a plurality of scan bar index locations; and
use the estimated paper shape profile to perform background compensation for the scanned image,

5. A non-transitory machine readable medium storing instructions executable by a processing resource to:
align a scan bar of the scanning device in each of a plurality of scan bar index locations;
perform a different respective scan bar calibration at each of the plurality of scan bar index locations; and
generate a different respective scan bar calibration table for each of a plurality of scan bar index locations using information from the associated scan bar calibration.

6. The medium of claim 5, wherein the instructions to align the scan bar include instructions to align the scan bar in a first scan bar index location among the plurality of scan bar index locations.

7. The medium of claim 6, further including instructions to:
pass a medium including a calibration target longitudinally across the scan bar; and
perform a scan bar calibration at the first scan bar index location based on color print and black print.

8. The medium of claim 5, wherein the instructions to align the scan bar include instructions to align the scan bar in a second scan bar index location among the plurality of scan bar index locations, wherein the second scan bar index location is different than a first scan bar index location.

9. The medium of claim 8, further including instructions to:
pass a medium including a calibration target longitudinally across the scan bar; and
perform a scan bar calibration at the second scan bar index location based on color print and black print.

10. A method comprising:
positioning a calibration page with a print face directed toward a scanning surface of a scanning device, wherein the calibration page includes a calibration target;
calibrating a scan bar of the scanning device by scanning the calibration target with the scanning device at a scan bar index location; and
generating a scan bar calibration table for the scan bar index location based on the scanned calibration target.

11. The method of claim 10, further comprising calibrating the scanning device by scanning the calibration target using the generated scan bar calibration target.

12. The method of claim 10, further comprising:
performing a carriage homing test on the scanning device; and
aligning the scan bar at a particular scan bar index location in response to a determination that the carriage homing test was successful.

13. The method of claim 10, wherein scanning the calibration target includes:
performing a scan bar calibration for a selected channel and resolution with white space above the calibration target.

14. The method of claim 10, wherein positioning the calibration page with the print face directed toward the scanning surface includes engaging a pressure plate in the scanning device to maintain the calibration page against the scanning surface.

15. The method of claim 10, wherein the scan bar index location is a first scan bar index location, the method including:
determining if the scan bar index location is a last scan bar index location; and
moving the scan bar to a second scan bar index location in response to a determination that the first scan bar index location is not the last scan bar index location.
